(19) United States
(12) Patent Application Publication
(10) Pub. No.: US 2003/0122648 A1
(43) Pub. Date: Jul. 3, 2003

(54) Inductor with an enclosed magnetic flux pattern and method of manufacturing the same

(76) Inventors: Chiung-Ting Ou, Tainan City (TW); Yu-Chen Lin, Chiai (TW)

Correspondence Address: FISH & RICHARDSON PC, 225 FRANKLIN ST, BOSTON, MA, 02110, US

(21) Appl. No.: 10/244,248

(22) Filed: Sep. 16, 2002

(30) Foreign Application Priority Data
Dec. 28, 2001 (TW) 90133036

(51) Int. Cl. H01F 5/00

(52) U.S. Cl. 336/200

(57) ABSTRACT

An inductor with an enclosed magnetic flux pattern. The inductor includes a semiconductor substrate; a first mask pattern formed on the semiconductor substrate; an inductor coil formed on the first mask pattern; and a second mask pattern formed on the inductor coil and connected to the first mask pattern through a plurality of plugs, such that an enclosed magnetic flux pattern is formed around the inductor coil.

### BACKGROUND OF THE INVENTION

1. Field of the Invention

The present invention relates to an inductor, and more particularly to an inductor with an enclosed magnetic flux pattern having good magnetism and conductivity.

2. Description of the Prior Art

For the RF (radio frequency) circuit application on a silicon substrate, an inductor is a necessary component. Conventionally, the “spiral” inductor is used. Given the properties of silicon substrates, substrate loss is an important issue to overcome. When the circuit needs a large inductor value, the parasitic loss effect will degrade the spiral inductor. In order to overcome this problem, a mask pattern P1 is predefined on a silicon substrate 2, as shown in FIG. 1A. Then, an inductor C1 is formed on the mask pattern P1. The mask pattern P1 generally includes four series of “L type” conductive lines disposed side by side, as shown in FIG. 1B. Each series of the “L type” conductive lines is separated. Thus, improper currents and major magnetic flux passing through the silicon substrate can be avoided. However, some of the magnetic flux will pass through the edge of the mask pattern to the silicon substrate resulting in the loss effect of the silicon substrate. In addition, since induced currents will cause electromagnetic fields, the inductor can interfere with outside circuits. Consequently, the circuit may not operate properly.

### SUMMARY OF THE INVENTION

In order to overcome the above problems, this invention provides an inductor with an enclosed magnetic flux pattern and method of manufacturing the same. In the present invention, two mask patterns are formed above and below the inductor coil, such that the parasitic effect of the inductor coil with outside circuits is avoided and paths of magnetic flux around the inductor coil are provided. Therefore, the magnetic flux of the inductor coil is for the most part in the enclosed path and the loss effect of the silicon substrate caused by magnetic flux is reduced.

The present invention achieves the above-indicated object by providing an inductor with an enclosed magnetic flux pattern. The inductor is formed on a semiconductor substrate. The inductor includes a first mask pattern, an inductor coil and a second mask pattern. The first mask pattern is formed on the semiconductor substrate. The inductor coil is formed on the first mask pattern. The second mask pattern is formed on the inductor coil. Via plugs and contact plugs are used to connect the first mask pattern with the second mask pattern, such that the inductor coil is enclosed by the first mask pattern and the second mask pattern to prevent the inductor coil from interacting with outside circuits.

The first mask pattern and the second mask pattern can be formed by patterning a polycrystalline silicon layer and a metal layer to form “L type” trenches, respectively. A “+ type” conductive line in the center of the “L type” trenches. Four regions divided by the “+ type” conductive line are provided with “L type” conductive lines disposed side by side.

The inductor coil is formed by patterning a plurality of metal layers to a form spiral circuit and a plurality of plugs.

Furthermore, the present invention provides a method of manufacturing an inductor with an enclosed magnetic flux pattern. Firstly, a semiconductor substrate is provided. Next, a first mask pattern is formed on the semiconductor substrate. Next, an inductor coil is formed on the first mask pattern. Finally, a second mask pattern is formed on the inductor coil and the second mask pattern is connected to the first mask pattern through a plurality of plugs, such that an enclosed magnetic flux pattern is formed around the inductor coil.

The formation of the first mask pattern includes the following steps. A polycrystalline silicon layer is provided. Next, the polycrystalline silicon layer is patterned to form “L type” patterns, such that a “+ type” conductive line and four regions divided by the “+ type” conductive line are formed, wherein each region has “L type” conductive lines disposed side by side.

The formation of the inductor coil includes the following steps. A plurality of metal layers are formed on the first mask pattern. Next, the metal layers are patterned to form a plurality of spiral patterns. Next, the spiral patterns are connected by a plurality of plugs to form the inductor coil.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1A (Prior Art) is a cross-section of a conventional inductor.

FIG. 1B (Prior Art) is a top-view of FIG. 1A.

FIG. 2 is a cross-section of an inductor in accordance with the present invention.

FIG. 3 is a top-view of FIG. 2.

FIG. 4 is a top-view of the first mask pattern and the second mask pattern in FIG. 2.

FIGS. 5A through 5H illustrate, in cross section, the process in accordance with the present invention.

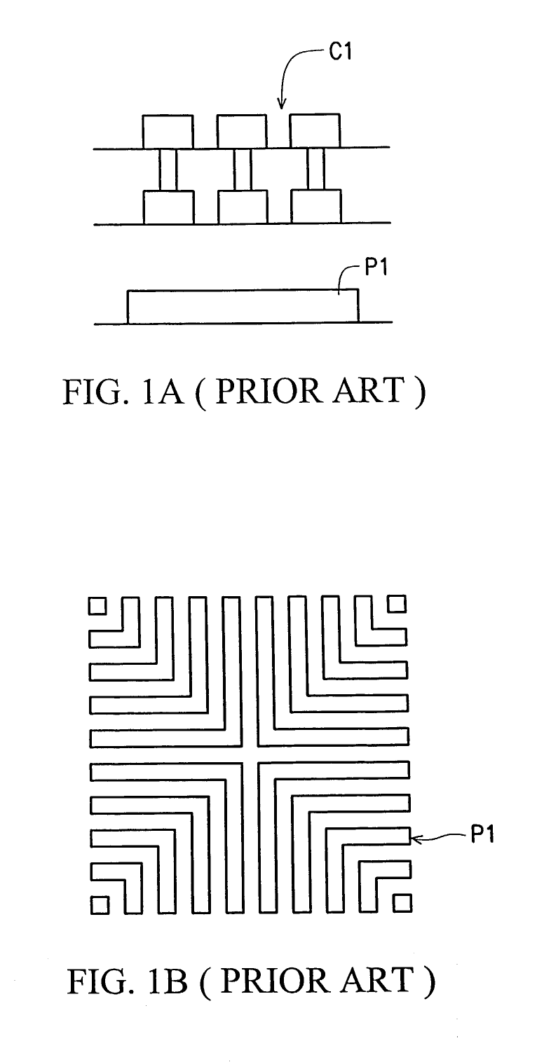

### DETAILED DESCRIPTION OF THE INVENTION

To prevent an inductor from interacting with outside circuits and the limit magnetic flux through the silicon substrate, two mask patterns are formed above and below an inductor coil, such that the parasitic effect of the inductor coil with outside circuits is avoided. The two mask patterns are connected by a plurality of plugs, such that an enclosed magnetic flux pattern is formed around the inductor coil.

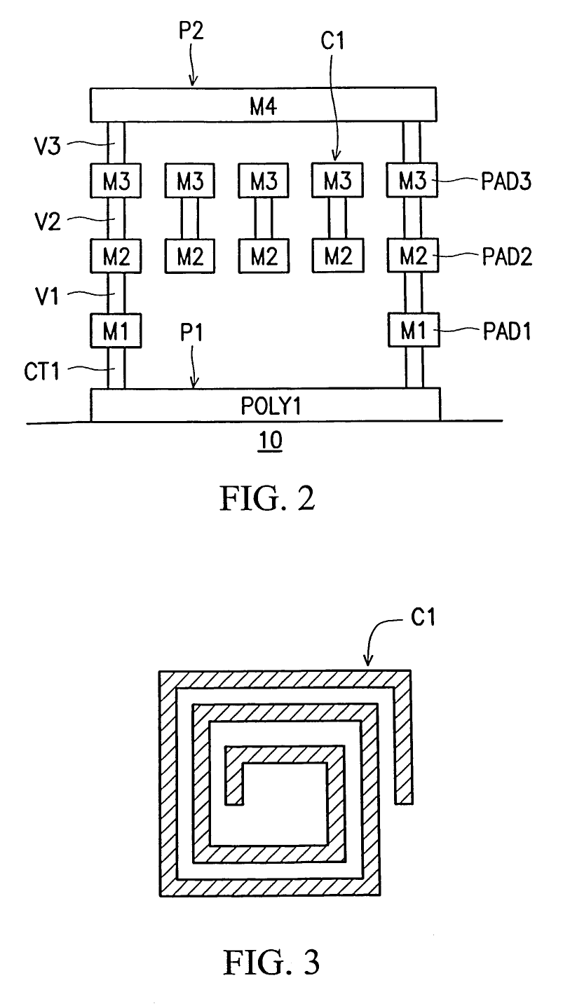

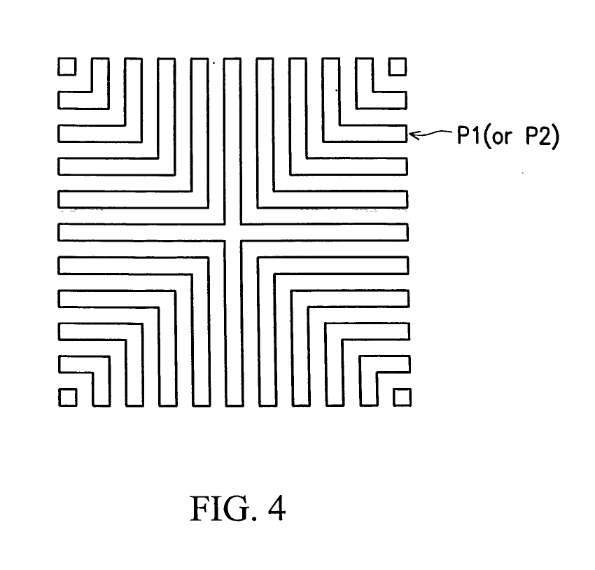

As shown in FIG. 2, an inductor is formed on a semiconductor substrate 10. The inductor includes a first mask pattern P1, an inductor coil C1 and a second mask pattern P2. The semiconductor substrate 10 can be a silicon substrate. The first mask pattern P1 can be formed by patterning a polycrystalline silicon layer POLY1 on the semiconductor substrate 10. The inductor coil C1 is formed by patterning a plurality of metal layers, such as M2 and M3, to form a spiral inductor on the first mask pattern P1, as shown in FIG. 3. The second mask pattern is formed by patterning a metal layer M4 on the inductor coil C1. Via plugs V1, V2 and V3 and contact plugs CT1 are used to connect the first mask pattern P1 with the second mask pattern P2, such that the inductor coil C1 is enclosed by the first mask pattern P1 and the second mask pattern P2 to prevent the inductor coil C1 from interacting with outside circuits. In this case, the first mask pattern P1 and the second mask pattern P2 can be formed by patterning the polycrystalline silicon layer POLY1 and the metal layer M4 to form “L type” patterns, respectively. A “+ type” conductive line is formed in the center of the “L type” patterns, as shown in FIG. 4. Four regions divided by the “+ type” conductive line are provided with “L type” conductive lines disposed side by side.

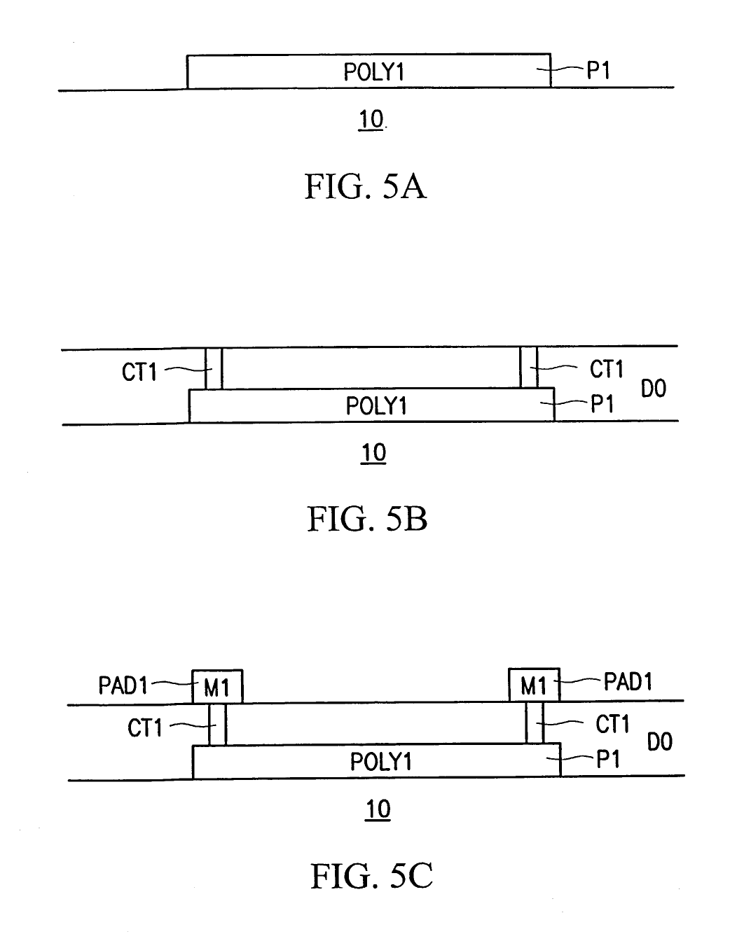

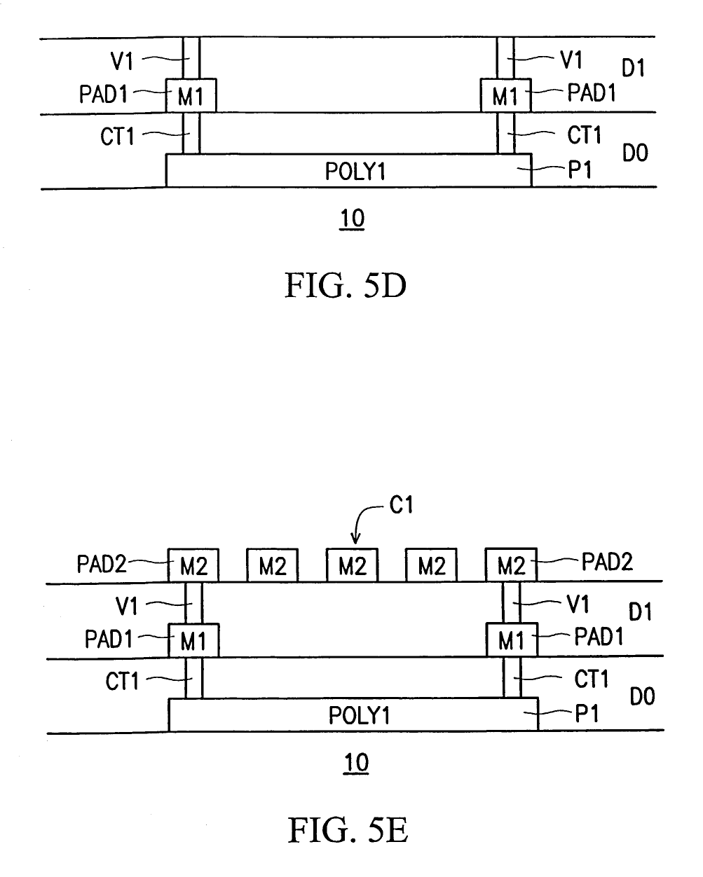

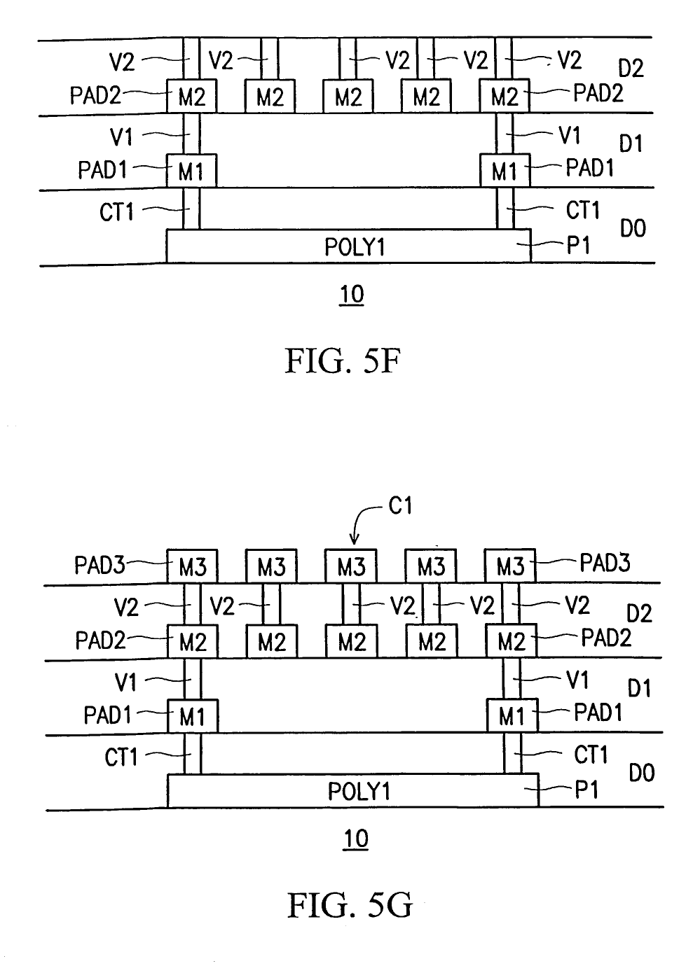

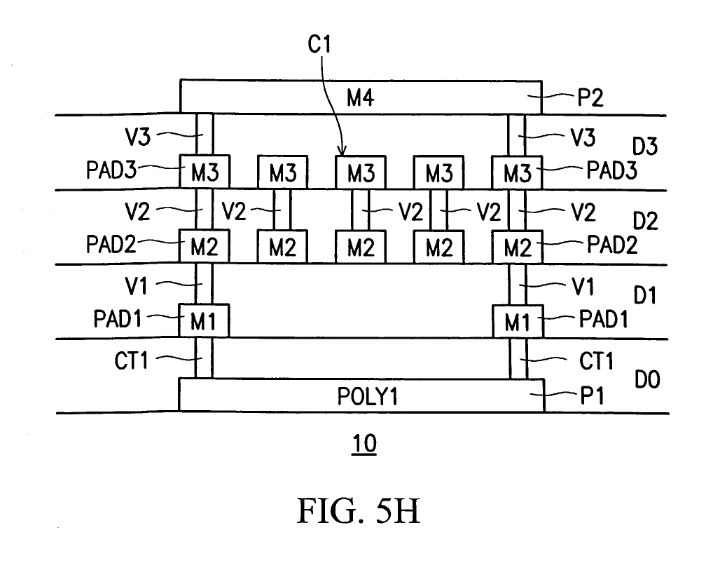

FIGS. 5A through 5H illustrate, in cross-section, the process in accordance with the present invention.

As shown in FIG. 5A, the polycrystalline silicon layer POLY1 is formed on the semiconductor substrate 10. The first mask pattern P1 is formed by patterning the polycrystalline silicon layer POLY1 on the semiconductor substrate 10. The first mask pattern P1 can be formed by patterning the polycrystalline silicon layer to form the “L type” patterns, as mentioned above. A “+ type” conductive line is formed in the center of the “L type” patterns. Four regions divided by the “+ type” conductive line are provided with “L type” conductive lines disposed side by side.

As shown in FIG. 5B, a dielectric layer D0 is formed on the polycrystalline silicon layer POLY1. The contact plugs CT1 are formed in the dielectric layer D0 and used to connect to the first mask pattern P1. In this case, the contact plugs CT1 are formed on the edge of the first mask pattern P1, such that the center of the first mask pattern P1 can be used to form the inductor coil.

As shown in FIG. 5C, a first metal layer M1 is formed on the dielectric layer D0. Contact pads PAD1 are formed by patterning the first metal layer M1 on the contact plugs CT1.

As shown in FIG. 5D, a first dielectric layer D1 is formed on the first metal layer M1. The via plugs V1 are formed in the first dielectric layer D1 on the contact pads PAD1.

As shown in FIG. 5E, a second metal layer M2 is formed on the first dielectric layer D1 and the via plugs V1. A spiral pattern C1 is formed by patterning the second metal layer M2 on the center of the first mask pattern P1. Contact pads PAD2 are formed by patterning the second metal layer M2 on the via plugs V1.

As shown in FIG. 5F, a second dielectric layer D2 is formed on the second metal layer M2. The via plugs V2 are formed in the second dielectric layer D2 on the contact pads PAD2 and the spiral pattern C1.

As shown in FIG. 5G, a third metal layer M3 is formed on the second dielectric layer D2 and the via plugs V2. A spiral pattern C1 is formed by patterning the third metal layer M3 centered on the first mask pattern P1. Contact pads PAD3 are formed by patterning the third metal layer M3 on the via plugs V2. In this case, via plugs V2 connect the spiral patterns formed by the second metal layer M2 and the third metal layer M3, such that the inductor coil C1 is formed.

As shown in FIG. 5H, a third dielectric layer D3 is formed on the third metal layer M3. The via plugs V3 are formed in the third dielectric layer D3 on the contact pads PAD3. Then, a fourth metal layer M4 is formed on the third dielectric layer D3. The second mask pattern P2 corresponding to the first mask pattern P1 is formed by patterning the fourth metal layer M4. The processes of forming the second mask pattern P2 is the same with the first mask pattern P1 and can be formed by patterning the fourth metal layer M4 to form the “L type” patterns, as mentioned above. A “+ type” conductive line is formed in the center of the “L type” patterns. Four regions divided by the “+ type” conductive line are provided with “L type” conductive lines disposed side by side.

In the present invention, because the second mask pattern P2 connects to the first mask pattern P1 through plugs V1, V2, V3 and CT1 and encloses the inductor coil C1, the inductor coil C1 is very well isolated from outside circuits. In addition, the first mask pattern P1 and the second mask pattern P2 are good paths of magnetic flux when there is current passing the inductor coil C1, such that the loss effect of the silicon substrate caused by magnetic flux is avoided.

To sum up, in the present invention, two mask patterns are formed above and below the inductor coil, such that the parasitic effect of the inductor coil with outside circuits is avoided and the paths of magnetic flux around the inductor coil is provided. Therefore, the magnetic flux of the inductor coil is for the most part in the enclosed path and the loss effect of the silicon substrate caused by magnetic flux is reduced.

It is to be understood that the present invention is not limited to the embodiments described above, but encompasses any and all embodiments within the scope of the following claims.

What is claimed is:

1. An inductor with an enclosed magnetic flux pattern, comprising:
a semiconductor substrate;
a first mask pattern formed on the semiconductor substrate;
an inductor coil formed on the first mask pattern; and
a second mask pattern formed on the inductor coil and connected to the first mask pattern through a plurality of plugs, such that an enclosed magnetic flux pattern is formed around the inductor coil.

2. The inductor as recited in claim 1, wherein the semiconductor substrate is a silicon substrate.

3. The inductor as recited in claim 1, wherein the first mask pattern is polycrystalline silicon.

4. The inductor as recited in claim 3, wherein the first mask pattern comprises a “+ type” conductive line and four regions divided by the “+ type” conductive line, wherein each region comprises “L type” conductive lines disposed side by side.

5. The inductor as recited in claim 4, wherein the first mask pattern is formed by patterning the polycrystalline silicon to form “L type” patterns.

6. The inductor as recited in claim 1, further comprising a first dielectric layer formed on the first mask pattern.

7. The inductor as recited in claim 6, wherein the inductor coil is formed on the first dielectric layer.

8. The inductor as recited in claim 7, wherein the inductor coil is a spiral type inductor coil formed by a plurality of metal layers.

9. The inductor as recited in claim 1, further comprising a second dielectric layer formed on the inductor coil.

10. The inductor as recited in claim 9, wherein the second mask pattern is formed on the second dielectric layer.

11. The inductor as recited in claim 1, wherein the second mask pattern is metal.

12. The inductor as recited in claim 11, wherein the second mask pattern comprises a “+ type” conductive line and four regions divided by the “+ type” conductive line, wherein each region comprises “L type” conductive lines disposed side by side.

13. The inductor as recited in claim 12, wherein the second mask pattern is formed by patterning the polycrystalline silicon to form “L type” patterns.

14. A method of manufacturing an inductor with an enclosed magnetic flux pattern comprising the steps of:
providing a semiconductor substrate;
forming a first mask pattern on the semiconductor substrate;
forming an inductor coil on the first mask pattern; and
forming a second mask pattern on the inductor coil and connecting the second mask pattern to the first mask pattern through a plurality of plugs, such that an enclosed magnetic flux pattern is formed around the inductor coil.

15. The method as recited in claim 14, wherein the semiconductor substrate is a silicon substrate.

16. The method as recited in claim 14, wherein the formation of the first mask pattern further comprises the steps of:
providing a polycrystalline silicon layer; and
patterning the polycrystalline silicon layer to form “L type” patterns, such that a “+ type” conductive line and four regions divided by the “+ type” conductive line are formed, and each region comprises “L type” conductive lines disposed side by side.

17. The method as recited in claim 14, further comprising the step of forming a first dielectric layer on the first mask pattern.

18. The method as recited in claim 14, wherein the formation of the inductor coil further comprises the steps of:
forming a plurality of metal layers on the first dielectric layer;
patterning the metal layers to form a plurality of spiral patterns; and
connecting the spiral patterns to form the inductor coil.

19. The method as recited in claim 18, wherein the spiral patterns are connected with each other by a plurality of plugs.

20. The method as recited in claim 14, further comprising the step of forming a second dielectric layer on the inductor coil.

21. The method as recited in claim 14, wherein the formation of the inductor coil further comprises the steps of:
providing a metal layer; and
patterning the metal layer to form “L type” patterns, such that a “+ type” conductive line and four regions divided by the “+ type” conductive line are formed, and each region comprises “L type” conductive lines disposed side by side.
